(19) United States
(12) Patent Application Publication
(10) Pub. No.: US 2018/0053220 A1
(43) Pub. Date: Feb. 22, 2018

(54) HIERARCHICAL PACING CONTROL FOR ACHIEVING MULTIPLE OBJECTIVES

(71) Applicant: Facebook, Inc., Menlo Park, CA (US)

(72) Inventor: Anand Sumatilal Bhalgat, Mountain View, CA (US)

(21) Appl. No.: 15/243,470

(22) Filed: Aug. 22, 2016

(51) Int. Cl. G06Q 30/02

(52) U.S. Cl. CPC G06Q 30/0273; G06Q 30/0246; G06Q 30/0276; G06Q 30/0277

(57) ABSTRACT

An advertising campaign has multiple objectives that the online system achieves by making appropriate bids for the advertising campaign. The online system presenting advertisement content modifies bid amounts associated with advertisements in the advertising campaign based on feedback about past performance of the advertising campaign. To satisfy the multiple objectives of the advertising campaign, the online system applies multiple mutually dependent pacing multipliers to determine and modify bid amounts of advertisements from the advertising campaign. One pacing multiplier is expressed in terms of the other pacing multiplier, and the online system modifies one pacing multiplier more frequently than the other pacing multiplier.

### BACKGROUND

This disclosure relates generally to optimizing advertisement bidding, and more specifically to hierarchical pacing control for achieving multiple objectives in an advertisement bidding process.

An online system, such as a social networking system, allows its users to connect to and communicate with other online system users. Users may create profiles on an online system that are tied to their identities and include information about the users, such as interests and demographic information. The users may be individuals or entities such as corporations or charities. Because of the increasing popularity of online systems and the increasing amount of user-specific information maintained by online systems, an online system provides an ideal forum for entities to increase awareness about products or services by presenting content items to online system users.

Presenting content items to online system users allows an entity to gain public attention for products or services or to persuade online users to take an action regarding the entity's products or services. Additionally, many online systems generate revenue by displaying certain content items to their users. Frequently, online systems charge entities for each presentation of certain types of content items to an online system user (e.g., each “impression” of the certain types of content items) or for each interaction with certain types of content items by an online system user. The display of an advertisement to a viewer of the advertisement is referred to herein as an advertising “impression.”

Online services, such as social networking systems, search engines, news aggregators, Internet shopping services, and content delivery services, have become a popular venue for presenting advertisements to prospective buyers. Some online services provide their services free of charge or charge only minimal fees. Instead, the online services generate revenue by presenting advertisements to users, who may take certain actions based on the presented advertisements (e.g., clicking on the advertisements). The advertisement-based online service model has spawned many diverse types of online services.

Online services often use a scheme that charges advertisement fees commensurate with the number of times the advertisements are displayed to the users or actions taken by the users in response to viewing the advertisements. The pricing structure widely used in online services for assessing advertisement fees includes, for example, Cost Per Impression (CPI), Cost Per Action (CPA), and Cost Per Thousand Impressions (Cost Per Mille or CPM). The CPI-based pricing structure assesses advertisement fees based on the number of instances an advertisement is loaded and displayed on a user's screen, typically in response to a user's request for a content item. The CPA-based pricing structure assesses advertisement fees based on actions taken by the users after the advertisements are displayed on the screen. The actions taken into account for the CPA-based pricing structure may include, among others, the following: (i) clicking on the advertisement, (ii) registration to the advertiser's service or product and (iii) conclusion of a sale of a service or product. The CPM-based pricing structure assesses advertisement fees based on dividing the cost of an advertising placement by the number of impressions (expressed in thousands) that it generates. The CPM can be used for comparing the relative efficiency of various advertising opportunities or media and in evaluating the overall costs of advertising campaigns. Rather than using CPI, CPM or CPA-based pricing structure, some online services charge a flat fee for displaying an advertisement for a certain amount of time.

Some online services adopt a bidding system that allows multiple advertisers to bid for advertisement space. When an advertisement is required for a particular advertisement space, the advertisement with the highest bidding price is selected and presented in the advertisement space to maximize the advertisement fees. The bidding price may be based on CPI, CPA, CPM or other expected revenue values. The bidding system may also employ a cap for limiting the amount of advertisement fees for a set period of time (e.g., day or month). The context of an advertisement may affect the value of the advertisement to an advertiser, and accordingly, may affect the amount the advertiser is willing to bid for the advertisement.

Additionally, many online systems commonly allow users (e.g., businesses) to sponsor presentation of content on an online system to gain public attention for a user's products or services or to persuade other users to take an action regarding the user's products or services. Content for which the online system receives compensation in exchange for presenting to users is referred to as “sponsored content.” Many online systems receive compensation from a user for presenting online system users with certain types of sponsored content provided by the user. Frequently, online systems charge a user for each presentation of sponsored content to an online system user or for each interaction with sponsored content by an online system user. For example, an online system receives compensation from an entity each time a content item provided by the user is displayed to another user on the online system or each time another user is presented with a content item on the online system and interacts with the content item (e.g., selects a link included in the content item), or each time another user performs another action after being presented with the content item (e.g., visits a physical location associated with the user who provided the content item).

### SUMMARY

An online system, such as a social networking system, receives information describing an advertising campaign (“ad campaign”) including one or more advertisements from an advertiser for presentation to one or more users of the online system. The online system receives information about a first objective of the ad campaign specifying a number of impressions to be delivered to the users of the online system under the ad campaign during a time interval of the ad campaign. The online system further receives information about a second objective of the ad campaign specifying a budget of the ad campaign that specifies a total amount of compensation the advertiser will provide the online system for presenting advertisements included in the ad campaign. Additionally, the information describing the ad campaign includes information for determining bid amounts associated with the advertisements included in the ad campaign. A bid amount associated with an advertisement specifies an amount of compensation received by the online system for presentation of the advertisement.

The online system also determines pacing multipliers associated with the ad campaign based at least in part on the first objective specifying a number of impressions to be delivered to the users of the online system under the ad campaign and the second objective specifying the budget for the ad campaign. In various embodiments, the online system determines, for each of a plurality of impression opportunities to deliver an advertisement to the users of the online system, a bid amount for the ad campaign based at least in part on the first pacing multipliers and the second pacing multiplier. During a plurality of different times during the time interval of the ad campaign, the online system modifies at least one of the first pacing multiplier and the second pacing multiplier based at least in part on whether the ad campaign is on pace to meet the first and the second objectives of the ad campaign. One pacing multiplier is expressed in terms of other pacing multiplier, and one pacing multiplier is modified more frequently than the other pacing multiplier during the ad campaign to achieve an equilibrium state.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3A illustrates an example graph of impression opportunity over time during advertisement bidding process, in accordance with an embodiment.

FIG. 3B illustrates an example graph of an average CPM (cost per thousand impressions) over time during advertisement bidding process, in accordance with an embodiment.

FIG. 4 is a flowchart of a method for hierarchical pacing control for achieving multiple objectives during an advertising campaign, in accordance with an embodiment.

FIG. 5 illustrates a process flow diagram of modifying bid amounts of advertisements under the advertising campaign, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

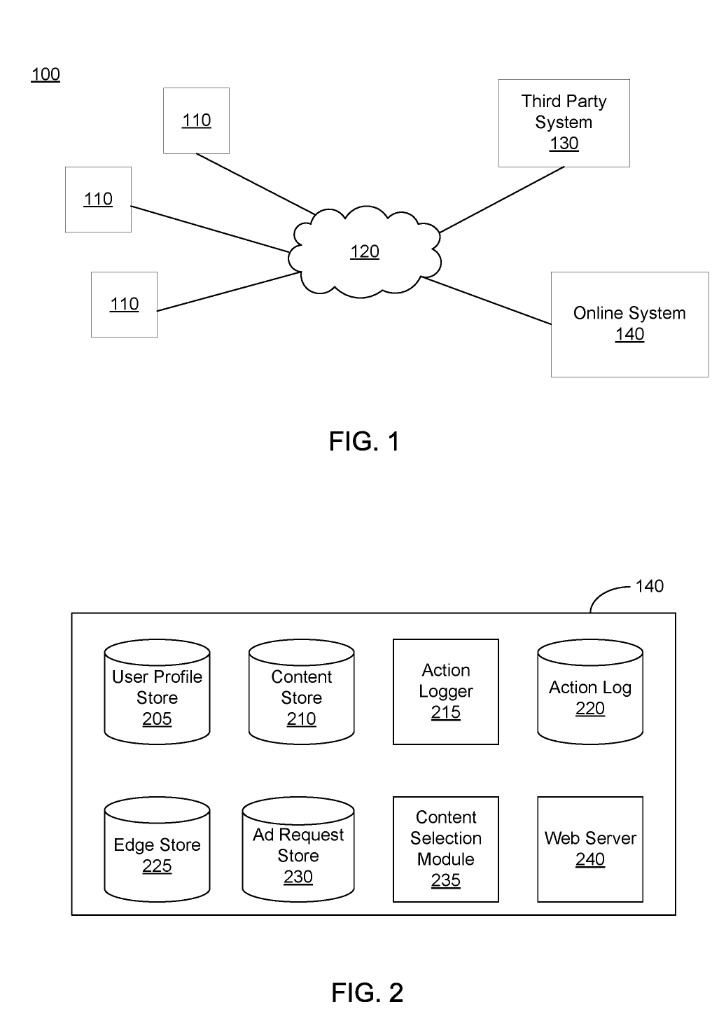

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. The embodiments described herein may be adapted to online systems that are social networking systems, content sharing networks, or other systems providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

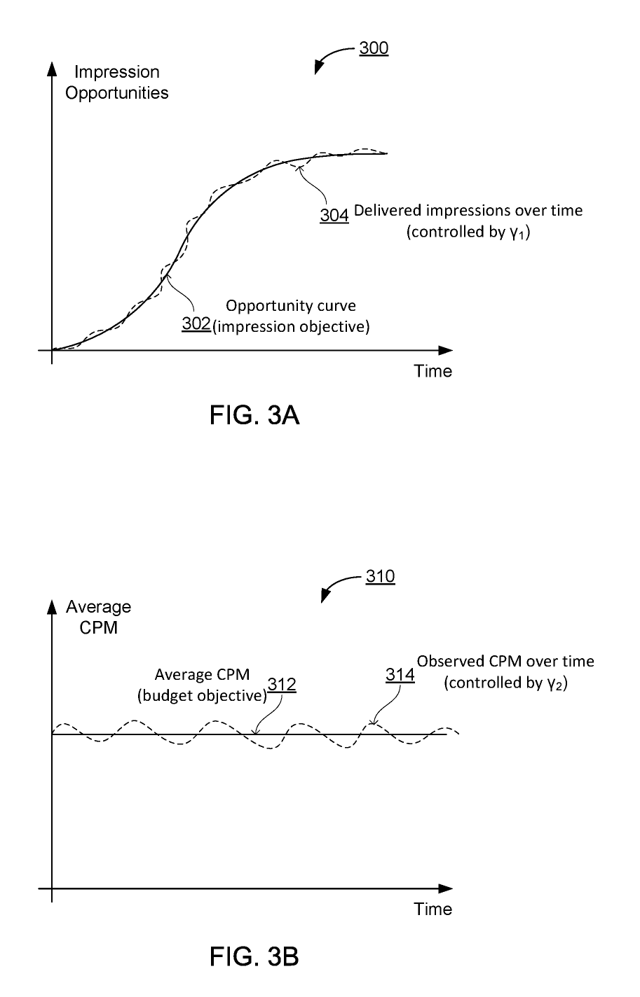

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device 110. In other embodiments, a third party system 130 provides content or other information for presentation via a client device 110. A third party system 130 may also communicate information to the online system 140, such as advertisements, content, or information about an application provided by the third party system 130.

In some embodiments, one or more of the third party systems 130 provide content to the online system 140 for presentation to users of the online system 140 and provide compensation to the online system 140 in exchange for presenting the content. For example, a third party system 130 provides advertisements of one or more advertising campaigns, which are further described below in conjunction with FIG. 2, including advertisements for presentation and amounts of compensation provided by the third party system 130 to the online system 140 in exchange to presenting the advertisements to the online system 140. Content presented by the online system 140 for which the online system 140 receives compensation in exchange for presenting is referred to herein as “sponsored content,” “sponsored content items,” or “advertisements.” Sponsored content from a third party system 130 may be associated with the third party system 130 or with another entity on whose behalf the third party system 130 operates.

FIG. 2 is a block diagram of an architecture of the online system 140. The online system 140 shown in FIG. 2 includes a user profile store 205, a content store 210, an action logger 215, an action log 220, an edge store 225, an advertisement (“ad”) request store 230, a content selection module 235, and a web server 240. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged and stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity. In some embodiments, the brand page associated with the entity's user profile may retrieve information from one or more user profiles associated with users who have interacted with the brand page or with other content associated with the entity, allowing the brand page to include information personalized to a user when presented to the user.

The content store 210 stores objects that each represents various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), engaging in a transaction, viewing an object (e.g., a content item), and sharing an object (e.g., a content item) with another user. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or a particular user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the ad request store 230. In various embodiments, the ad request store 230 includes one or more ad requests, each ad request representing a request from an advertiser to serve an advertisement to one or more users of the online system 140 during an advertising campaign (“ad campaign”). An ad campaign includes one or more advertisements for presentation to one or more users of the online system 140. The ad campaign is associated with one or more objectives, a budget and duration. An objective associated with an ad campaign describes one or more goals for presentation of advertisements during the ad campaign. For example, an objective specifies a total number of impressions of advertisements to be delivered to the users of the online system 140 under the ad campaign during a time interval of the ad campaign. The budget specifies a total amount of compensation a user (e.g., an advertiser) associated with an ad campaign provides the online system 140 for presenting advertisements to the users of the online system 140.

Additionally, the duration associated with the ad campaign specifies a time interval during which advertisements are presented to social networking system users. For example, if the duration of an ad campaign is 30 days, advertisements included in the ad campaign are presented to online system users for 30 days after the ad campaign is provided to the online system 140. In some embodiments, the user providing the ad campaign may also specify a start date for the ad campaign, so the duration is measured from the specified start date.

An advertising campaign includes one or more advertisements for presentation to one or more social networking system users. An advertisement includes advertisement content and a bid amount. The advertisement is text, image, audio, video, or any other suitable data presented to a user. The advertisement may also include a landing page specifying a network address to which a user is directed when the advertisement content is accessed. In some embodiments, the bid amount is associated with an advertisement by a user providing the advertisement to the online system 140 and is used to determine an expected value, such as monetary compensation, provided by the user to the online system 140 if the advertisement is presented to another user, if the advertisement receives an interaction from another user presented with the advertisement, or if any suitable condition is satisfied when the advertisement is presented to another user. For example, the bid amount specifies a monetary amount that the online system 140 receives from an advertiser if an advertisement is displayed. In some embodiments, the expected value to the online system 140 of presenting the advertisement may be determined by multiplying the bid amount by a probability of the advertisement being accessed by a user.

Alternatively, the user providing an advertisement to the online system 140 does not associate a bid amount with the advertisement, but the online system 140 determines a bid amount for the advertisement based on a budget, a duration, or an objective associated with the ad campaign including the advertisement. For example, a pacing factor is determined from the budget associated with an ad campaign including the advertisement and an amount spent by an advertiser on the ad campaign from a start date of the ad campaign to a current time. The pacing factor modifies a bid amount associated with various advertisements in the ad campaign, altering spending of the ad campaign's budget throughout the duration of the ad campaign.

Additionally, an ad request may include one or more targeting criteria specified by the user providing the ad request to the online system 140 (e.g., an advertiser). Targeting criteria included in an ad request specify one or more characteristics of users eligible to be presented with advertisement content. For example, targeting criteria are used to identify users having user profile information, edges, or actions satisfying at least one of the targeting criteria. Hence, targeting criteria allow a user to identify other users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users who have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows further refinement of users eligible to be presented with an advertisement from an ad request. As another example, targeting criteria identifies users having a connection to another user or object or having a particular type of connection to another user or object.

The content selection module 235 selects one or more content items for communication to a client device 110 to be presented to a user. Content items eligible for presentation to the user are retrieved from the content store 210, from the ad request store 230, or from another source by the content selection module 235, which selects one or more of the content items for presentation to the user. A content item eligible for presentation to the user is a content item associated with at least a threshold number of targeting criteria satisfied by characteristics of the user or is a content item that is not associated with targeting criteria. In various embodiments, the content selection module 235 includes content items eligible for presentation to the user in one or more selection processes, which identify a set of content items for presentation to the user. For example, the content selection module 235 determines measures of relevance of various content items to the user based on characteristics associated with the user by the online system 140 and based on the user's affinity for different content items. Information associated with the user included in the user profile store 205, in the action log 220, and in the edge store 225 may be used to determine the measures of relevance. Based on the measures of relevance, the content selection module 235 selects content items for presentation to the user. As an additional example, the content selection module 235 selects content items having the highest measures of relevance or having at least a threshold measure of relevance for presentation to the user. Alternatively, the content selection module 235 ranks content items based on their associated measures of relevance and selects content items having the highest positions in the ranking or having at least a threshold position in the ranking for presentation to the user.

Content items selected for presentation to the user may include advertisements or other content items associated with bid amounts. The content selection module 235 uses the bid amounts associated with advertisements when selecting content for presentation to the viewing user. In various embodiments, the content selection module 235 determines an expected value associated with various advertisements (or other content items) based on their bid amounts and selects advertisements associated with a maximum expected value or associated with at least a threshold expected value for presentation. An expected value associated with an advertisement or with a content item represents an expected amount of compensation to the online system 140 for presenting an advertisement or for presenting the content item. For example, the expected value associated with an advertisement is a product of the advertisement's bid amount and a likelihood of the user interacting with the advertisement content. The content selection module 235 may rank advertisements based on their associated bid amounts and select advertisements having at least a threshold position in the ranking for presentation to the user. In some embodiments, the content selection module 235 ranks both content items not associated with bid amounts and advertisements in a unified ranking based on bid amounts associated with advertisements and measures of relevance associated with content items and with advertisements. Based on the unified ranking, the content selection module 235 selects content for presentation to the user. Selecting advertisements and other content items through a unified ranking is further described in U.S. patent application Ser. No. 13/545,266, filed on Jul. 10, 2012, which is hereby incorporated by reference in its entirety.

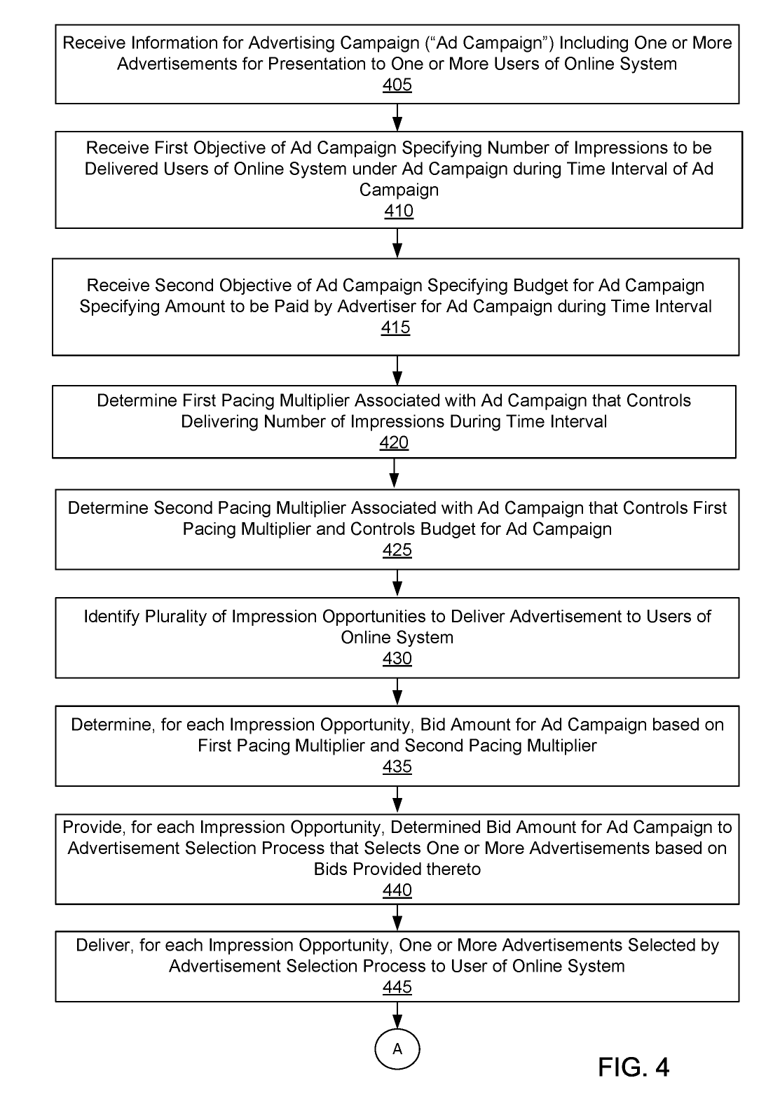

When the online system 140 receives an ad campaign including advertisements, the online system 140 determines bid amounts for advertisements in the ad campaign and modifies pacing multipliers associated with the ad campaign for modifying the bid amounts. The online system 140 modifies a bid amount associated with an advertisement of the ad campaign and selects one or more advertisements for presentation to online system users based on their bid amounts. The online system 140 modifies the bid amount of the advertisement based on the pacing multipliers associated with the ad campaign and communicates the advertisement along with the modified bid amount to an advertisement selection process. As one or more advertisements are selected by the advertisement selection process for presentation to online system users, the online system 140 further modifies the pacing multipliers associated with the ad campaign to achieve multiple objectives of the ad campaign , as further described below in conjunction with FIGS. 3A, 3B, 4 and 5.

The web server 240 links the online system 140 via the network 120 to the one or more client devices 110, as well as to the one or more third party systems 130. The web server 240 serves web pages, as well as other content, such as JAVA®, FLASH®, XML and so forth. The web server 240 may receive and route messages between the online system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 240 may provide application programming interface (API) functionality to send data directly to native client device operating systems, such as IOS®, ANDROID™, WEBOS® or BlackberryOS.

Hierarchical Pacing Control for Achieving Multiple Objectives during Advertising Campaign

Embodiments of the present disclosure relate to an advertising campaign (“ad campaign”) that has multiple objectives, such as a budget that can be spent during the ad campaign and a number of impressions to be delivered to users of the online system 140 under the ad campaign during a time interval of the ad campaign. In some embodiments, the online system 140 can achieve the multiple objectives by making appropriate bids for the ad campaign. Two pacing multipliers represented by two control variables can be utilized for achieving the multiple objectives during the ad campaign by modifying a bid amount for the ad campaign on a per-impression basis. As discussed in more detail below, the bid amount for the ad campaign can be adjusted based on feedback about past performance of the ad campaign, i.e., based on whether the ad campaign is on pace to meet the first and the second objectives. In accordance with embodiments of the present disclosure, to achieve an equilibrium state, one pacing multiplier represented by one control variable can be expressed in terms of another pacing multiplier represented by another control variable. In some embodiments, as discussed in more detail below, fast aggressive control can be used for one pacing multiplier and associated control variable, whereas slower and less aggressive control can be employed for the other pacing multiplier and the other control variable associated with the other pacing multiplier.

Certain embodiments of the present disclosure relate to a control system for advertisement bidding, wherein the control system has a goal of reaching multiple objectives during an ad campaign, such as an objective specifying a budget for the ad campaign specifying an amount to be paid by an advertiser for the ad campaign during a time interval of the ad campaign and another objective specifying a number of impressions to be delivered to users of the online system 140 under the ad campaign during the time interval. In some embodiments, the control system for advertisement bidding may be a part of the content selection module 235 of the online system 140 illustrated in FIG. 2 or some other module of the online system 140, which can modify a bid amount associated with an advertisement of the ad campaign based on feedback about past performance of the ad campaign.

The multiple objectives in the ad campaign can be achieved based on simultaneous pacing of the multiple objectives during a time interval of the ad campaign. In some embodiments, the simultaneous pacing of multiple objectives during the time interval of the ad campaign implies utilizing multiple pacing multipliers for obtaining a bid amount for each advertisement. Each pacing multiplier can be associated with a specific control variable representing an output of a control sub-system, which can be implemented in certain embodiments as a part of the content selection module 235 or as a part of some other module of the online system 140.

In some embodiments, a bid amount associated with an advertisement of an ad campaign can be expressed as:

λ₁×eCVR+λ₂, (1)

where λ₁ is a first control variable or a first pacing multiplier that controls an objective specifying a budget for the ad campaign, λ₂ is a second control variable or a second pacing multiplier that controls another objective specifying a number of impressions to be delivered to online system users during a time interval of the ad campaign, and eCVR is an expected value for a conversion rate of the ad campaign. The first control variable λ₁ can be provided as an output of a budget control sub-system that may be implemented at the content selection module 235 or some other module of the online system 140, i.e., a budget control algorithm can produce the first control variable λ₁. Similarly, the second control variable λ₂ can be provided as an output of an impression control sub-system that may be implemented at the content selection module 235 or some other module of the online system 140, i.e., an impression control algorithm can produce the second control variable λ₂. In some embodiments, the content selection module 235 may perform both the budget control and the impression control.

The method for determining the bid amount defined by equation (1) can be employed if both control variables λ₁ and λ₂ are known and pre-defined. However, the method defined by equation (1) cannot be operable if both the first control variable λ₁ and the second control variable λ₂ are not known and need to be learned. In an illustrative embodiment, when the first control variable λ₁ increases, the second control variable λ₂ decreases, which changes impression delivery during an ad campaign. Also, if the second control variable λ₂ decreases, an objective specifying a budget for an ad campaign is negatively affected and can decrease. Thus, it can be observed that when a control system for advertisement bidding is designed as a part of the online system 140 having multiple independent control variables trying to achieve multiple objectives, these control variables mutually interact and an equilibrium solution cannot be achieved. Rather than achieving the equilibrium solution, the control variables of the advertisement bidding control system defined by equation (1) experience oscillator behavior or non-smooth behavior.

In the illustrative embodiment of applying the method for determining a bid amount for an advertisement defined by equation (1) for controlling an advertisement bidding process, achieving an objective specifying a budget for the ad campaign can be controlled by the first control variable λ₁, whereas achieving another objective specifying a number of impressions to be delivered to online system users during a time interval of the ad campaign can be controlled by the second control variable λ₂. However, controlling of the first control variable λ₁ affects impression driven controlling of the second control variable λ₂, which affects a budget for an ad campaign in an uncontrollable manner without an equilibrium solution. Thus, the approach for determining bid amounts during an ad campaign based on mapping constraints directly to control variables cannot produce a desired equilibrium state.

Embodiments of the present disclosure support a control system for advertisement bidding based on two (or more) control variables that are mutually dependent. The control system for advertisement bidding can be implemented as a part of the content selection module 235 of the online system 140 or some other module of the online system 140. In some embodiments, a first control variable γ₁ only affects an objective of the ad campaign specifying a number of impressions to be delivered to online system users during a time interval of the ad campaign (i.e., impression objective of an ad campaign); and a second control variable γ₂ affects both the impression objective and another objective specifying a budget for the ad campaign that specifies an amount to be paid by an advertiser for the ad campaign during the time interval of the ad campaign (i.e., budget objective). Therefore, the first control variable γ₁ may affect the impression objective, whereas the second control variable γ₂ may affect both the control variable γ₁ and the budget objective. In this way, independent bid structures for controlling of a bidding process can be avoided, such as the independent bid structures defined by equation (1) based on the aforementioned control variables λ₁ and λ₂ that behave independently. In the preferred embodiment presented herein, the control variables γ₁ and γ₂behave mutually dependent on each other. The presented method for designing a control system for an advertisement bidding process described in more detail below provides mutually dependent control variables. In some embodiments, the control system with mutually dependent control variables may be implemented as a part of the online system 140, such as the content selection module 235.

In accordance with embodiments of the present disclosure, in the case of dependent control variables for controlling multiple objectives in an advertisement bidding process, an advertisement bid may be defined as:

γ₁×(CPM_{bid}+γ₂×eCVR×Conv_{bid}), (2)

where CPM_{bid} is a cost per thousand impressions, eCVR is an expected value for a conversion rate of the ad campaign, and Conv_{bid} is a conversion bid of the ad campaign. It can be observed from equation (2) that CPM_{bid} has a dependence on the first control variable γ₁, whereas Conv_{bid} is affected by the product factor γ₁×γ₂ , i.e., Conv_{bid} is affected by both the first and second control variables or by two pacing multipliers. In an illustrative embodiment, an advertiser provides an objective to the online system 140 specifying a budget of $1,000 that represents a budget objective, and CPM_{bid} is $10. Then, the maximum conversion rate can be achieved with 100,000 impressions, which represents an impression objective. The bidding process for this ad campaign is controlled at the online system 140 based on the control variables γ₁ and γ₂ such that to achieve both the budget objective and the impression objective, and a bid amount for an advertisement of the ad campaign can be determined in accordance with equation (2).

For some embodiments, Conv_{bid} is affected by the control variables γ₁ and γ₂ in dependent form, i.e., Conv_{bid} is affected by two hierarchical pacing multipliers, wherein one pacing multiplier represented by the first control variable γ₁ is expressed in terms of the other pacing multiplier represented by the second control variable γ₂. In this case, the second pacing multiplier associated with the second control variable γ₂ affects the first pacing multiplier associated with the first control variable γ₁, i.e., the second pacing multiplier associated with the second control variable γ₂ has a higher hierarchical level than the first pacing multiplier associated with the first control variable γ₁. On the other hand, CPM_{bid} is affected by only one control variable, γ₁, i.e., only one pacing multiplier associated with the first control variable γ₁ affects CPM_{bid}. In some embodiments, the first and the second pacing multipliers can be implemented within the content selection module 235 of the online system 140 or some other module of the online system 140.

In one or more embodiments, the first control variable γ₁ can be paced based on an impression objective thus providing impression control for an advertisement bidding. In the same time, the second control variable γ₂ can control an average CPM_{bid} over time thus providing CPM-based control for the advertisement bidding. Hence, the multiplication of the control variables γ₁ and γ₂in equation (2) can be proportional to a conversion budget, i.e.,

$${γ}_{1} \times {γ}_{2} ⇔ \frac{conv . budget}{{γ}_{1}} . \qquad ( 3 )$$

FIG. 3A illustrates an example graph 300 of a number of impression opportunities over time during an advertisement bidding process defined by equation (2), in accordance with an embodiment. In some embodiments, an impression opportunity represents an opportunity when the online system 140 is able to serve an advertisement to an online system user. In an embodiment, an impression opportunity can be a pull opportunity, such as a page refresh, a use of a mobile application, etc. In another embodiment, an impression opportunity can be a push opportunity, such as a notification about an advertisement. The curve 302 shown in FIG. 3A represents an example of an opportunity curve, i.e., an example objective specifying a number of impressions to be delivered to one or more online system users during a time interval of an ad campaign. The curve 304 shown in FIG. 3A illustrates an example on how impression opportunities are delivered over time during the advertisement bidding process, which can be controlled by the first control variable γ₁ or the first pacing multiplier. Thus, the first control variable γ₁ can be paced such that the opportunity curve 302 representing the impression objective is closely followed during the time interval of the ad campaign, as represented by the curve 304 in FIG. 3A.

FIG. 3B illustrates an example graph 310 of an average CPM over time during the advertisement bidding process defined by equation (2), in accordance with an embodiment. The curve 312 shown in FIG. 3B represents an example objective specifying an average CPM during a time interval of an ad campaign. The curve 314 shown in FIG. 3B illustrates an example of an observed CPM over time during the time interval of the ad campaign, which can be controlled by the second control variable γ₂ or the second pacing multiplier. Thus, the second control variable γ₂ can be paced such that the average CPM over time during the time interval of the ad campaign is controlled as desired, represented by the curve 314 in FIG. 3B.

As discussed, for the method of controlling advertisement bidding defined by equation (1), the two control variables λ₁ and λ₂ would control a budget objective and an impression objective, respectively. However, due to mutual interactions, the control variables λ₁ and λ₂ cannot be paced in a proper way to control both the budget objective and the impression objective while eventually providing an equilibrium solution. Unlike the method defined by equation (1), in the case of controlling advertisement bidding defined by equation (2), directly controlling a budget can be avoided. Instead, controlling of an average CPM is performed, which provides another definition for the second control variable γ₂, i.e., the second control variable γ₂ controls an average CPM over time during a time interval of an advertisement bidding process.

In accordance with embodiments of the present disclosure, an advertiser desires to deliver impressions smoothly, while an objective specifying a budget for an ad campaign can be missed sometimes. In an illustrative embodiment, for contracted advertisements, it is possible to miss a budget objective by approximately between 5% and 10% of the budget target. For example, a contract for an advertisement can be made with an advertiser for a budget objective of $1,000, while CPM_{bid} is $10. An advertiser prefers to deliver 100,000 impressions over a certain period of time even if this particular amount of impression delivery would cost $1,100 instead of the budget objective of $1,000. The miss in the budget objective of 10% can be offset at some later time for some other ad campaign, such as by delivering 100,000 impressions for $900 instead of the budget objective of $1,000. Thus, a budget is intrinsically a soft objective rather than a constraint, which facilitates the presented method for controlling an advertisement bidding process (ad campaign) based on two dependent control variables.

In some embodiments, the control variables γ₁, γ₂ and corresponding pacing multipliers can have different learning rates. In one or more embodiments, the first control variable γ₁ that provides the impression control can have a fast and aggressive learning rate, such as the first control variable γ₁ can be modified per impression and have a learning rate per minute. Referring back to FIG. 3A, the goal is to follow the opportunity curve 302 representing the impression objective as close as possible most of the time during a time interval of an ad campaign, i.e., a number of delivered impressions during the time interval represented by the curve 304 should be as close as possible to the opportunity curve 302 representing the impression objective for most of the time during the time interval of the ad campaign.

In the same time, the second control variable γ₂ that controls an average CPM over time during the time interval of the ad campaign can have a slow learning rate, thus providing less aggressive control of the average CPM. As discussed above, it may be allowable to miss a budget objective at the end of the ad campaign. In the meantime, an observed average CPM can fluctuate from an average CPM objective during the time interval of the ad campaign. Referring back to FIG. 3B, the curve 314 illustrating the observed CPM over time during the time interval of the ad campaign that is controlled by the second control variable γ₂ does not need to closely follow the average CPM objective represented by the line 312. Hence, the second control variable γ₂ can have a slower control rate or, equivalently, a slower learning rate, in comparison with the first control variable γ₁.

In some embodiment, during controlling of the advertisement bidding process by the online system 140, the first control variable γ₁ has an opportunity to react fast and adjust impression delivery without the second control variable γ₂ reacting at all, thus not immediately adjusting the observed CPM. Since the control variables γ₁ and γ₂ can learn at different rates, the control of advertisement bidding process based on the control variables γ₁ and γ₂ can achieve an equilibrium solution. In contrast, as discussed in relation to the advertisement bidding process defined by equation (1), control variables would never converge when the control variables learn at similar rates.

The presented system for control of advertisement bidding implemented at the online system 140 is therefore based on mutually dependent control variables that have different learning rates. The second control variable γ₂ that provides control for average CPM has a slower learning rate thus allowing certain modifications of the average CPM objective. In contrast, the first control variable γ₁ that provides impression control has a faster learning rate and can efficiently adjust its value in order to closely follow the impression objective, as illustrated in FIG. 3A.

In addition, as discussed, a budget for an ad campaign is not a tight function or a tight constraint. In an illustrative embodiment, an advertiser wants to spend $1,000 with CPM_{bid} of $10. During an ad campaign, it is possible to have impression delivery with CPM_{bid} of $11 that is later compensated by other impression delivery having CPM_{bid} of $9. It is however preferred for advertising to always deliver 100,000 impressions uniformly. The bidding process where a budget is a soft objective and a number of impressions to be delivered to online system users during a time interval of an ad campaign is a hard objective can be efficiently controlled by the control system presented herein having hierarchical pacing control based on mutually dependent control variables having different learning rates.

### Operations for Hierarchical Pacing Control

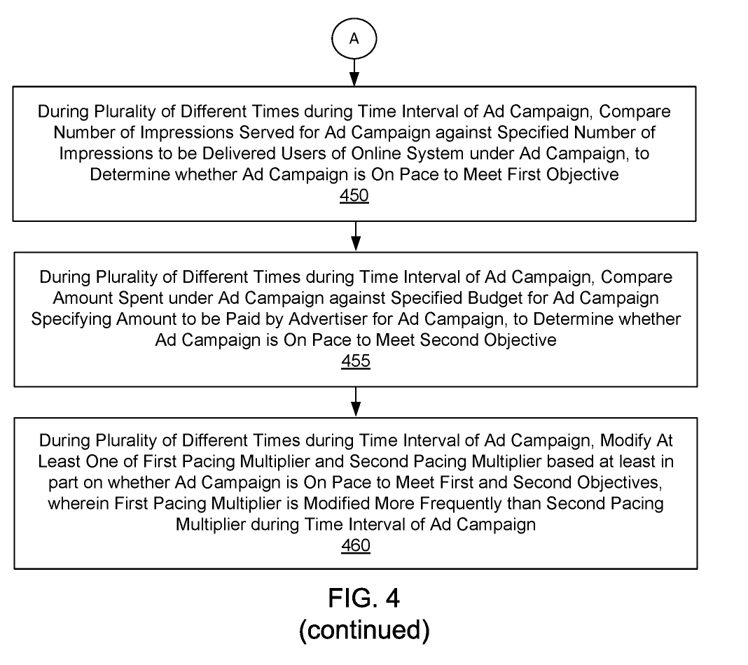

FIG. 4 is a flowchart of one embodiment of a method for hierarchical pacing control for achieving multiple objectives during advertisement bidding process. In various embodiments, the steps described in conjunction with FIG. 4 may be performed in different orders than the order described in conjunction with FIG. 4. Additionally, the method may include different and/or additional steps than those described in conjunction with FIG. 4 in some embodiments.

The online system 140 receives 405 information for an advertising campaign (“ad campaign”) including one or more advertisements for presentation to one or more users of the online system 140. In some embodiments, an advertiser may provide the information for the ad campaign including one or more advertisements to the online system 140. The information for the ad campaign may include instructions for determining bid amounts for advertisements in the ad campaign. For example, the information includes instructions for allocating a budget among advertisements in the ad campaign based on one or more criteria (e.g., an amount of the budget remaining, an amount of an objective that has been completed, an amount of a time interval of the ad campaign remaining, and so on).

The online system 140 receives 410 (e.g., from the advertiser) a first objective of the ad campaign specifying a number of impressions to be delivered to the users of the online system 140 under the ad campaign during a time interval of the ad campaign. The online system 140 further receives 415 (e.g., from the advertiser) a second objective specifying a budget for the ad campaign that specifies an amount of compensation to be paid by the advertiser for the ad campaign during the time interval of the ad campaign. If the information describing the ad campaign does not include any objective or a sufficient number of objectives, the online system 140 may identify one or more objectives of the ad campaign by requesting one or more objectives from the advertiser, or by inferring one or more objectives based on a number or percentage of characteristics of the ad campaign matching other ad campaigns associated with the advertiser having one or more objectives and inferring the one or more objectives as objective(s) associated with at least a threshold number of other ad campaigns associated with the advertiser having at least a threshold number or percentage of characteristics matching characteristics of the ad campaign.

The online system 140 determines 420 a first pacing multiplier associated with the ad campaign that controls delivering the number of impressions during the time interval of the ad campaign. In some embodiments, as discussed, the first pacing multiplier is represented by the first control variable γ₁, which modifies bid amounts of advertisements included in the ad campaign in accordance with equation (2) so that the objective specifying the number of impressions to be delivered to the users of the online system 140 under the ad campaign during the time interval of the ad campaign is achieved, as illustrated by the curve 304 in FIG. 3A.

Additionally, the online system 140 determines 425 a second pacing multiplier associated with the ad campaign that controls the first pacing multiplier and controls the budget for the ad campaign. In some embodiments, as discussed, the second pacing multiplier is represented by the second control variable γ₂, which modifies bid amounts of advertisements included in the ad campaign in accordance with equation (2) such that a CPM observed during the time interval of the ad campaign (see curve 314 in FIG. 3B) closely follows an average CPM objective (see line 312 in FIG. 3B). Determination and use of pacing multipliers is further described in U.S. patent application Ser. No. 13/294,094, filed on Nov. 10, 2011, which is hereby incorporated by reference in its entirety.

The online system 140 identifies 430 a plurality of impressions to deliver an advertisement to the users of the online system 140. In some embodiments, an impression opportunity represents an opportunity when the online system 140 is able to serve an advertisement to an online system user. In an embodiment, an impression opportunity can be a pull opportunity, such as a page refresh, a use of a mobile application, etc. In another embodiment, an impression opportunity can be a push opportunity, such as a notification about an advertisement.

In some embodiments, for each of the impression opportunities, the online system 140 determines 435 a bid amount for the ad campaign based at least in part on the first pacing multiplier and the second pacing multiplier factored into the bid determination such that an increase in either the first pacing multiplier or the second pacing multiplier increases the bid amount and a decrease in either the first pacing multiplier or the second pacing multiplier decreases the bid amount, as defined by equation (2). In some embodiments, a bid amount associated with the advertisement may be combined with the first pacing multiplier and the second pacing multiplier using any suitable operation to determine 435 the bid amount of the advertisement, such as operation in accordance with equation (2). Determining (and modifying) 435 a bid amount of an advertisement using a pacing multiplier is further described in U.S. patent application Ser. No. 13/294,094, filed on Nov. 10, 2011, which is incorporated by reference in its entirety as stated previously.

For each of the impression opportunities, the online system 140 provides 440 the determined bid amount for the ad campaign to an advertisement selection process that selects one or more advertisements based on bids provided thereto. In some embodiments, the content selection module 235 of the online system 140 performs the advertisement selection process. The content selection module 235 selects through the advertisement selection process content for presentation to the users of the online system 140, such as one or more advertisements for presentation to the users via an impression opportunity of the identified impression opportunities. For example, the advertisement selection process is an auction based on the determined bid amount for the ad campaign and other bid amounts of advertisements from other ad campaigns. In some embodiments, the advertisement selection process ranks the advertisement from the ad campaign and advertisements from other ad campaigns based on the determined bid amount and the other bid amounts, respectively. In some embodiments, advertisements having at least a threshold position in the ranking or at least a threshold bid amount are selected for presentation to the users of the online system 140.

For each of the impression opportunities, the online system 140 delivers 445 the one or more advertisements selected by the advertisement selection process to a user of the online system 140. In some embodiments, when the advertisement selection process selects the one or more advertisements for presentation, the one or more advertisements are communicated to a client device 110 for presentation to a user of the online system 140.

During a plurality of different times during the time interval of the ad campaign, the online system 140 compares 450 a number of impressions served for the ad campaign against the specified number of impressions to be delivered to the users of the online system 140 under the ad campaign, to determine whether the ad campaign is on pace to meet the first objective. As illustrated in FIG. 3A, the number of impressions served for the ad campaign illustrated by the curve 304 controlled by the first control variable γ₁ and the first pacing multiplier is compared 450 against the specified number of impressions to be delivered to the users illustrated by the curve 302 so as the curve 304 closely follows the impression objective curve 302.

During the plurality of different times during the time interval of the ad campaign, the online system 140 compares 455 an amount spent under the ad campaign against the specified budget for the ad campaign specifying an amount to be paid by the advertiser for the ad campaign, to determine whether the ad campaign is on pace to meet the second objective. As illustrated in FIG. 3B, a CPM observed during the ad campaign illustrated by the curve 314 controlled by the second control variable γ₂ and the second pacing multiplier is compared 455 against an average CPM objective illustrated by the line 312, so as the amount spent under the ad campaign is within an acceptable margin from the average CPM objective.

During the plurality of different times during the time interval of the ad campaign, the online system 140 modifies 460 at least one of the first pacing multiplier represented by the first control variable γ₁ and the second pacing multiplier represented by the second control variable γ₂ based at least in part on whether the ad campaign is on pace to meet the first and the second objectives. In some embodiments, the online system 140 modifies 460 the first pacing multiplier at a different rate than the second pacing multiplier. In an embodiment, the online system 140 modifies 460 the first pacing multiplier represented by the first control variable γ₁ more frequently than the second pacing multiplier represented by the second control variable γ₂ during the time interval of the ad campaign. For example, the online system 140 modifies 460 the first pacing multiplier represented by the first control variable γ₁ after each impression opportunity of an advertisement from the ad campaign, such that a number of impressions delivered during the plurality of different times during the time interval of the ad campaign closely follows an impression objective. This is illustrated by the curve 304 in FIG. 3A representing a number of delivered impressions during the plurality of different times during the time interval of the ad campaign controlled by the first control variable γ₁ closely following the opportunity curve 302 representing the impression objective. The online system 140 modifies 460 the first pacing multiplier based on the objective specifying a number of impressions to be delivered to online system users under the ad campaign to satisfy the objective without exceeding the budget, as further described in U.S. patent application Ser. No. 13/294,094, filed on Nov. 10, 2011, which is incorporated by reference in its entirety. In some embodiments, as discussed, the online system 140 modifies 460 the second pacing multiplier represented by the second control variable γ₂ less frequently that the first pacing multiplier represented by the first control variable γ₁, i.e., a learning rate of the second control variable γ₂ is faster that a learning rate of the first control variable γ₁. The objective of modifying the second pacing multiplier represented by the second control variable γ₂is to adjust, at a certain defined rate, a CPM observed during the time interval of the ad campaign (see curve 314 in FIG. 3B) based on an average CPM objective (see line 312 in FIG. 3B).

Modifying Pacing Multipliers Based on Feedback about Past Performance of Advertising Campaign

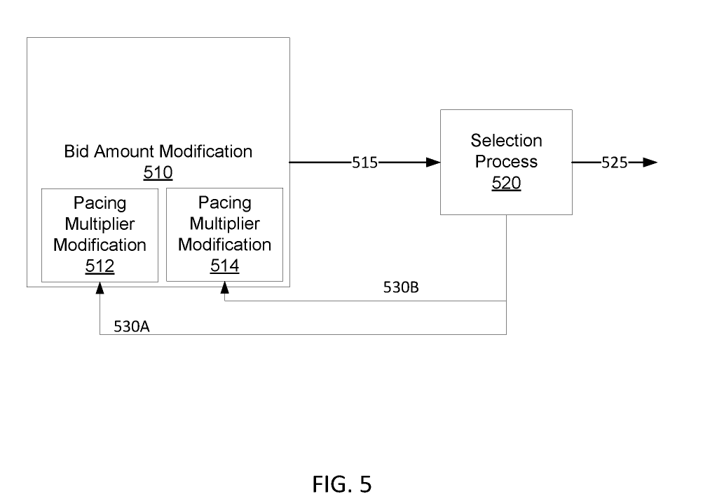

FIG. 5 is a process flow diagram of modifying bid amounts of advertisements under the advertising campaign (“ad campaign”) based on selection of advertisements for presentation to online system users and a feedback about past performance of the ad campaign. A bid amount modification process 510 modifies bid amounts of advertisements included in an ad campaign. The bid amount modification process 510 may be performed by the content selection module 235 or some other module of the online system 140. Bid amounts for the ad campaign are communicated 515 to a selection process 520, which selects one or more advertisements 525 for presentation to online system users based on the bid amounts for the ad campaign and other bid amounts for one or more other ad campaigns provided to the selection process 520. The selection process 520 may be performed by the content selection module 235 or some other module of the online system 140. In various embodiments, an advertiser provides to the bid amount modification process 510 a first objective of the ad campaign specifying a number of impressions to be delivered to online system users under the ad campaign during a time interval of the ad campaign. Additionally, the advertiser provides to the bid amount modification process 510 a second objective of the ad campaign specifying a budget for the ad campaign specifying an amount to be paid by the advertiser for the ad campaign during the time interval.

As described above in conjunction with FIG. 4, the online system 140 determines a bid amount associated with an advertisement in the ad campaign based at least in part on the first pacing multiplier represented by the first control variable γ₁ and the second pacing multiplier represented by the second control variable γ₂. In some embodiments, the first and second pacing multipliers are factored into the bid determination such that an increase in either the first pacing multiplier or the second pacing multiplier increases the bid amount and a decrease in either the first pacing multiplier or the second pacing multiplier decreases the bid amount, as defined by equation (2). The online system 140 modifies through the bid amount modification process 510 the bid amount by at least one of modifying 512 the first pacing multiplier (i.e., the first control variable γ₁) and modifying 514 the second pacing multiplier (i.e., the second control variable γ₂) based at least in part on whether the ad campaign is on pace to meet the first and the second objectives. In some embodiments, as discussed, the first control variable γ₁ controls a number of delivered impressions during a time interval of the ad campaign to closely follow the impression objective, which is represented by the curve 304 in FIG. 3A closely following the impression objective illustrated by the opportunity curve 302 in FIG. 3A. The first control variable (i.e., the first pacing multiplier) γ₁ modifies 512 in accordance with a fast learning rate, and provides fast and aggressive control of a bid amount. On the other hand, the second control variable γ₂ provides CPM-based control such that a CPM observed during a time interval of the ad campaign (see curve 314 in FIG. 3B) is based on an average CPM objective (see line 312 in FIG. 3B). The second control variable (i.e., the second pacing multiplier) γ₂ modifies 514 in accordance with a learning rate slower than the learning rate of the first control variable γ₁ since a delivered average CPM over time does not need to be aggressively controlled with respect to the average CPM objective. Thus, in some embodiments, the online system 140 modifies through the bid amount modification process 510 bid amounts associated with various advertisements by modifying 512 the first pacing multiplier (i.e., the first control variable γ₁) more frequently than modifying 514 the second pacing multiplier (i.e., the second control variable γ₂). The online system 140 provides the determined bid amount 515 to the selection process 520 that selects one or more advertisements 525 based on the bid amount provided thereto. The selection process 520 delivers the selected one or more advertisements 525 to online system users.

The bid amount modification process 510 applies the first and second pacing multipliers to modify bid amounts of advertisements from the ad campaign to achieve multiple objectives, such as a number of impressions to be delivered during a time interval of the ad campaign and an average CPM observed during the time interval of the ad campaign. As one or more advertisements 525 from the ad campaign are selected for presentation to users by the selection process 520, information 530A and information 530B from the selection process 520 are communicated to the bid amount modification process 510. The bid amount modification process 510 modifies 512 the first pacing multiplier based on information 530A from the selection process 520 and modifies 514 the second pacing multiplier based on information 530B from the selection process 520. For example, the selection process 520 indicates in information 530A a number of impressions served for the ad campaign. The bid amount modification process 510 compares the number of impressions served for the ad campaign provided in the information 530A against the specified number of impressions to be delivered to the users, to determine whether the ad campaign is on pace to meet the first objective. The selection process 520 further indicates in information 530B an amount spent under the ad campaign (e.g., an observed CPM during a time interval of the ad campaign). The bid amount modification process 510 compares the amount spent under the ad campaign provided in the information 530B against the specified budget for the ad campaign, to determine whether the ad campaign is on pace to meet the second objective. The bid amount modification process 510 performs at least one of modification 512 of the first pacing multiplier and modification 514 of the second pacing multiplier 514 based at least in part on whether the ad campaign is on pace to meet the first and the second objectives.

The bid amount modification process 510 modifies 512 the first pacing multiplier and modifies 514 the second pacing multiplier at different rates. In an embodiment, the bid amount modification process 510 modifies 512 the first pacing multiplier more frequently than the second pacing multiplier is modified 514. For example, the bid amount modification process 510 modifies 512 the first pacing multiplier after each impression opportunity to deliver an advertisement to online system users, while modifying 514 the second pacing multiplier is performed less frequently in relation to a spent portion of the budget during the advertising campaign represented by an observed CPM for a time interval during the ad campaign. In various embodiments, the bid amount modification process 510 modifies 512 the first pacing multiplier represented by the first control variable γ₁ in response to receiving an indication about modification 514 of the second pacing multiplier represented by the second control variable γ₂. In some embodiments, as discussed, the first control variable γ₂ provides impression control, whereas the second control variable γ₂ provides both budget control and control for the first control variable γ₁ achieving a control system with mutually dependent control variables. In this way, the second pacing multiplier represented by the second control variable γ₂ has a higher hierarchical level than the first pacing multiplier represented by the first control variable γ₁.

In some embodiments, the bid amount modification process 510 increases 512 the first pacing multiplier to increase the bid amount when the number of impressions served for the ad campaign provided in the information 530A is behind pace to meet the first objective, i.e., when the curve 304 in FIG. 3A is behind pace of the impression objective curve 302. Similarly, the bid amount modification process 510 decreases 512 the first pacing multiplier to decrease the bid amount when the number of impressions served for the ad campaign provided in the information 530A is ahead of pace to meet the first objective. In some embodiments, the bid amount modification process 510 increases 514 the second pacing multiplier to increase 512 the first pacing multiplier and the bid amount when the amount spent under the ad campaign provided in the information 530B is behind pace to meet the second objective, i.e., when the observed CPM 314 shown in FIG. 3B does follow the average CPM objective 312 within a defined margin. Similarly, the bid amount modification process 510 decreases 514 the second pacing multiplier to decrease 512 the first pacing multiplier and the bid amount when the amount spent under the ad campaign provided in the information 530B is ahead of pace to meet the second objective.

In some embodiments, the bid amount modification process 510 modifies 514 the second pacing multiplier based at least in part on an observed CPM over time during the time interval of the ad campaign, which is provided in the information 530B. In an embodiment, the modification 514 of the second pacing multiplier includes increasing 514 the second pacing multiplier to increase the bid amount when the observed CPM is behind pace to meet the second objective. Alternatively, the modification 514 of the second pacing multiplier includes decreasing 514 the second pacing multiplier to decrease the bid amount when the observed CPM is ahead of pace to meet the second objective.

### Summary

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving information for an advertising campaign (“ad campaign”) including one or more advertisements for presentation to one or more users of an online system;
receiving a first objective of the ad campaign specifying a number of impressions to be delivered to the users of the online system under the ad campaign during a time interval of the ad campaign;
receiving a second objective of the ad campaign specifying a budget for the ad campaign specifying an amount to be paid by the advertiser for the ad campaign during the time interval;
determining a first pacing multiplier associated with the ad campaign that controls delivering the number of impressions during the time interval;
determining a second pacing multiplier associated with the ad campaign that controls the first pacing multiplier and controls the budget for the ad campaign;
identifying a plurality of impression opportunities to deliver an advertisement to the users of the online system;
for each of the impression opportunities:
determining a bid amount for the ad campaign based at least in part on the first pacing multiplier and the second pacing multiplier factored into the bid determination such that an increase in either the first pacing multiplier or the second pacing multiplier increases the bid amount and a decrease in either the first pacing multiplier or the second pacing multiplier decreases the bid amount;
providing the determined bid amount for the ad campaign to an advertisement selection process that selects one or more advertisements based on bids provided thereto, and
delivering the one or more advertisements selected by the advertisement selection process to a user of the online system; and
during a plurality of different times during the time interval of the ad campaign:
comparing a number of impressions served for the ad campaign against the specified number of impressions to be delivered to the users of the online system under the ad campaign, to determine whether the ad campaign is on pace to meet the first objective,
comparing an amount spent under the ad campaign against the specified budget for the ad campaign specifying the amount to be paid by the advertiser for the ad campaign, to determine whether the ad campaign is on pace to meet the second objective, and
modifying at least one of the first pacing multiplier and the second pacing multiplier based at least in part on whether the ad campaign is on pace to meet the first and the second objectives, wherein
the first pacing multiplier is modified more frequently than the second pacing multiplier during the time interval of the ad campaign.

2. The method of claim 1, wherein modifying the at least one of the first pacing multiplier and the second pacing multiplier comprises:
increasing the first pacing multiplier to increase the bid amount when the number of impressions served for the ad campaign is behind pace to meet the first objective; and
decreasing the first pacing multiplier to decrease the bid amount when the number of impressions served for the ad campaign is ahead of pace to meet the first objective.

3. The method of claim 1, wherein modifying the at least one of the first pacing multiplier and the second pacing multiplier comprises:
increasing the second pacing multiplier to increase the first pacing multiplier and the bid amount when the amount spent under the ad campaign is behind pace to meet the second objective; and
decreasing the second pacing multiplier to decrease the first pacing multiplier and the bid amount when the amount spent under the ad campaign is ahead of pace to meet the second objective.

4. The method of claim 1, wherein modifying the at least one of the first pacing multiplier and the second pacing multiplier comprises:
modifying the second pacing multiplier based at least in part on an observed cost per thousand impressions (CPM) over time during the time interval of the ad campaign.

5. The method of claim 4, wherein modifying the second pacing multiplier based at least in part on the observed CPM comprises:
increasing the second pacing multiplier to increase the bid amount when the observed CPM is behind pace to meet the second objective; and
decreasing the second pacing multiplier to decrease the bid amount when the observed CPM is ahead of pace to meet the second objective.

6. The method of claim 1, wherein modifying the at least one of the first pacing multiplier and the second pacing multiplier comprises:
modifying the first pacing multiplier in response to receiving an indication of the modification of the second pacing multiplier.

7. The method of claim 1, wherein modifying the at least one of the first pacing multiplier and the second pacing multiplier comprises:
modifying the second pacing multiplier in response to receiving information about reaching the budget for the ad campaign.

8. The method of claim 1, wherein modifying the at least one of the first pacing multiplier and the second pacing multiplier comprises:
modifying the first pacing multiplier in response to each impression served for the ad campaign.

9. The method of claim 1, wherein:
the second pacing multiplier comprises the first pacing multiplier multiplied by a value;
the value being increased relative to a previous value when the amount spent under the ad campaign is behind pace to meet the second objective given a current time of the time interval of the ad campaign; and
the value being decreased relative to a previous value when the amount spent under the ad campaign is ahead of pace to meet the second objective given a current time of the time interval of the ad campaign.

10. A computer program product comprising a computer-readable storage medium having instructions encoded thereon that, when executed by a processor, cause the processor to:
receive information for an advertising campaign (“ad campaign”) including one or more advertisements for presentation to one or more users of an online system;
receive a first objective of the ad campaign specifying a number of impressions to be delivered to the users of the online system under the ad campaign during a time interval of the ad campaign;
receive a second objective of the ad campaign specifying a budget for the ad campaign specifying an amount to be paid by the advertiser for the ad campaign during the time interval;
determine a first pacing multiplier associated with the ad campaign that controls delivering the number of impressions during the time interval;
determine a second pacing multiplier associated with the ad campaign that controls the first pacing multiplier and controls the budget for the ad campaign;
identify a plurality of impression opportunities to deliver an advertisement to the users of the online system;
for each of the impression opportunities:
determine a bid amount for the ad campaign based at least in part on the first pacing multiplier and the second pacing multiplier factored into the bid determination such that an increase in either the first pacing multiplier or the second pacing multiplier increases the bid amount and a decrease in either the first pacing multiplier or the second pacing multiplier decreases the bid amount;
provide the determined bid amount for the ad campaign to an advertisement selection process that selects one or more advertisements based on bids provided thereto, and
deliver the one or more advertisements selected by the advertisement selection process to a user of the online system; and
during a plurality of different times during the time interval of the ad campaign:
compare a number of impressions served for the ad campaign against the specified number of impressions to be delivered to the users of the online system under the ad campaign, to determine whether the ad campaign is on pace to meet the first objective,
compare an amount spent under the ad campaign against the specified budget for the ad campaign specifying the amount to be paid by the advertiser for the ad campaign, to determine whether the ad campaign is on pace to meet the second objective, and
modify at least one of the first pacing multiplier and the second pacing multiplier based at least in part on whether the ad campaign is on pace to meet the first and the second objectives, wherein
the first pacing multiplier is modified more frequently than the second pacing multiplier during the time interval of the ad campaign.

11. The computer program product of claim 10, wherein modify the at least one of the first pacing multiplier and the second pacing multiplier comprises:
increase the first pacing multiplier to increase the bid amount when the number of impressions served for the ad campaign is behind pace to meet the first objective; and
decrease the first pacing multiplier to decrease the bid amount when the number of impressions served for the ad campaign is ahead of pace to meet the first objective.

12. The computer program product of claim 10, wherein modify the at least one of the first pacing multiplier and the second pacing multiplier comprises:
increase the second pacing multiplier to increase the first pacing multiplier and the bid amount when the amount spent under the ad campaign is behind pace to meet the second objective; and
decrease the second pacing multiplier to decrease the first pacing multiplier and the bid amount when the amount spent under the ad campaign is ahead of pace to meet the second objective.

13. The computer program product of claim 10, wherein modify the at least one of the first pacing multiplier and the second pacing multiplier comprises:
modify the second pacing multiplier based at least in part on an observed cost per thousand impressions (CPM) over time during the time interval of the ad campaign.

14. The computer program product of claim 13, wherein modify the second pacing multiplier based at least in part on the observed CPM comprises:
increase the second pacing multiplier to increase the bid amount when the observed CPM is behind pace to meet the second objective; and
decrease the second pacing multiplier to decrease the bid amount when the observed is ahead of pace to meet the second objective.

15. The computer program product of claim 10, wherein modify the at least one of the first pacing multiplier and the second pacing multiplier comprises:
modify the first pacing multiplier in response to receiving an indication of the modification of the second pacing multiplier.

16. The computer program product of claim 10, wherein modify the at least one of the first pacing multiplier and the second pacing multiplier comprises:
modify the second pacing multiplier in response to receiving information about reaching the budget for the ad campaign.

17. The computer program product of claim 10, wherein modify the at least one of the first pacing multiplier and the second pacing multiplier comprises:
modify the first pacing multiplier in response to each impression served for the ad campaign.

18. The computer program product of claim 10, wherein:
the second pacing multiplier comprises the first pacing multiplier multiplied by a value;
the value being increased relative to a previous value when the amount spent under the ad campaign is behind pace to meet the second objective given a current time of the time interval of the ad campaign; and
the value being decreased relative to a previous value when the amount spent under the ad campaign is ahead of pace to meet the second objective given a current time of the time interval of the ad campaign.
